(19) United States
(12) Patent Application Publication
(10) Pub. No.: US 2012/0300319 A1
(43) Pub. Date: Nov. 29, 2012

(54) SPORTS EQUIPMENT IMAGE VIEWER

(76) Inventor: Karim J. Ziyad, Stone Mountain, GA (US)

(21) Appl. No.: 13/518,956

(22) PCT Filed: Dec. 23, 2010
(86) PCT No.: PCT/US10/62011

§ 371 Date: Jun. 25, 2012

Related U.S. Application Data
(60) Provisional application No. 61/284,769, filed on Dec. 26, 2009.

(51) Int. Cl. G02B 25/02; B23P 11/00; G02B 27/02

(52) U.S. Cl. 359/798; 359/809; 29/428

(57) ABSTRACT

A sports equipment image viewer includes an article of sports equipment and an image viewer. The article of sports equipment has a cavity. The image viewer is inserted into the cavity, and includes an image. As such, the image is inside the article of sports equipment.

### RELATED PATENT APPLICATIONS

The present patent application claims the benefit of and priority to the U.S. provisional patent application having the same title, filed on Dec. 26, 2009, and assigned U.S. provisional patent application No. 61/284,769.

### BACKGROUND OF THE INVENTION

Many people in the United States and other countries have a certain fascination, if not addictive, to amateur, collegiate, and professional sports of almost all types. Popular sports have a large number of recreational players, and even a larger following of enthusiastic fans. Star athletes, successful as well as unsuccessful clubs, programs, and winning teams ignite passions within their respective constituencies.

### SUMMARY OF THE INVENTION

A sports equipment image viewer of an embodiment of the invention includes an article of sports equipment having a cavity, and an image viewer inserted into the cavity. The image viewer includes an image. As such, the image is inside the article of sports equipment.

A method of an embodiment of the invention includes providing an article of sports equipment that is cored so that the article of sports equipment includes a cavity. The method includes providing an image viewer adapted to be inserted within the article of sports equipment. The method includes positioning the image viewer within the cavity of the article of sports equipment such that the image viewer is inserted into the cavity of the article of sports equipment. The method includes securing the image viewer within the cavity of the article of sports equipment such that the image viewer is united with the article of sports equipment.

### BRIEF DESCRIPTION OF THE DRAWINGS

The drawings referenced herein form a part of the specification. Features shown in the drawing are meant as illustrative of only some embodiments of the invention, and not of all embodiments of the invention, unless otherwise explicitly indicated, and implications to the contrary are otherwise not to be made.

FIG. 1 is a cross-sectional diagram of an image viewer, according to an embodiment of the invention.

FIG. 2 is a cross-sectional diagram of an article of sports equipment in combination with the image viewer of FIG. 1, according to an embodiment of the invention.

### DETAILED DESCRIPTION

In the following detailed description of exemplary embodiments of the invention, reference is made to the accompanying drawings that form a part hereof, and in which is shown by way of illustration specific exemplary embodiments in which the invention may be practiced. These embodiments are described in sufficient detail to enable those skilled in the art to practice the invention. Other embodiments may be utilized, and logical, mechanical, and other changes may be made without departing from the spirit or scope of the present invention. The following detailed description is, therefore, not to be taken in a limiting sense, and the scope of the embodiment of the invention is defined only by the appended claims.

As noted in the background section, sports are very popular. Many fans yearn to have in their possession pictures of their favorite athletes and teams, and/or items associated with certain athletes or teams, such as baseballs, golf balls, tennis balls, and novelty items associated with sports. Handheld and other transparency viewers exist within the prior art for users to view images on transparency film. Novelty sports equipment viewers in particular, adapt sports equipment with sport images, and utilize ambient light sources to provide light on a translucent surface to permit negatives, transparencies, slides, and the like, to be viewed.

Such a sports equipment viewer typically includes a magnifying lens that is positioned as an opening in particular relation to a holder for a mounted transparency or slide. The opposite side of the viewer includes a translucent window, and the slide binder window exposing the transparency is positioned between the magnifier lens and this opposite window to provide a signal opening of sufficient duct-through that ambient light can enter. When a slide is positioned in the holder, a user observes the transparency through the magnifying lens.

However, such sports equipment viewers have certain deficiencies. Ambient light that can normally be expected to illuminate the transparency for viewing also illuminates the side of the transparency facing the user. This in turn results in unwanted reflections, particularly specular reflections on the front side of the transparency facing the user. Furthermore, it is difficult to view images with clarity when ambient lighting conditions are less than favorable. Images can appear spotty if the user points the viewer directly at a light source, such as the sun or a light fixture. When the user is in a dark area, with limited ambient light, the image is very difficult to view if at all.

Furthermore, because existing sports equipment viewers are designed with openings at opposite ends, users can become confused. Specifically, a user may be uncertain into which end the user should look. When the user looks into the translucent window opposite the magnification lens, the user will just see a blurred image, and at worst may believe that the sports equipment viewer in question is faulty.

Embodiments of the invention overcome these disadvantages. The inventive sports equipment viewer provides for uniform light. As such, the viewer permits a user to view the transparency with clarity regardless of ambient light conditions, unfettered from sports or reflections. The inventive viewer can have just one opening, so as not to confuse the user, and further is economical to manufacture. Other advantages of the invention are stated and will become apparent throughout the detailed description.

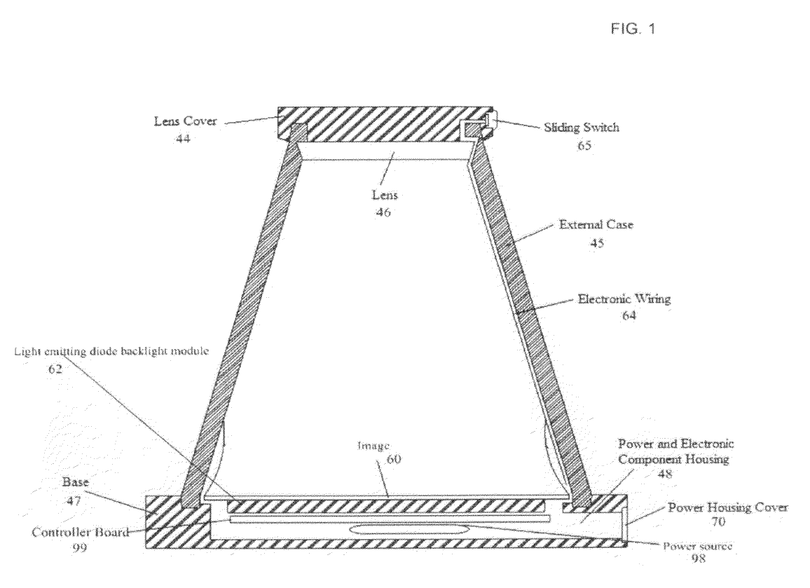

FIG. 1 shows a cross-sectional view of an image viewer, according to an embodiment of the invention. The image viewer includes a lens cover 44, an external case 45, an optical magnification lens 46, a bottom, seat, or base 47, a power and electronic component housing 48, a picture, picture on a transparency slide, or image 60, a light source, bulb light, light emitting diode (LED) or LED backlight module 62, an electronic wiring 64, a switch, push button switch or sliding switch 65, and a power housing cover 70. The lens cover 44, external case 45, base 47, sliding switch 65, and power housing cover 70 are made of molded plastic. The optical magnification lens 46 is made of either glass or plastic. The electronic wiring 64 can be made of copper or other suitable conductive material.

The base 47 is seated below external case 45. It is contemplated that the external case 45 of the image viewer of FIG. 1 have a cylindrical shape. However, it should be understood that other shapes and configurations may be used to form the external case 45, including, without limitation to, rectangular, oval, oblong, circular etc. It is contemplated that the external case 45 is made up of two halves of molded plastic (other materials may also be used, however), grooved at the pinnacle and bottom, measuring approximately 1½ inches in length and ½ inches in width, and having bi-lateral symmetry. Each half contains an inner groove in the upper and lower portion, and male prongs measuring approximately ⅛ inches long protruding on one side of inner wall and holes matching diameter of prongs on opposite side of inner wall. The optical lens 46 is inserted in between grooves of the upper portion of the inner walls of external case 45. The image 60 is inserted between grooves of the lower portion of the inner walls of external case 45.

It is contemplated that image 60 is a picture on a transparency slide. The image 60 is not so limited, however, and may vary, such that it can be a still digital image, a moving image, or a video image as discussed in alternative embodiment. It is contemplated that the external case 45 has two halves. It is contemplated that the two halves of external case 45 are snapped together inserting prongs on one half of external case 45 into holes on the other half. Alternatively, the two halves of the external case 45 can be fused together during the manufacturing molding process. The lower portion of external case 45 is mounted within base 47 through a similar process of reciprocation; inserting manufactured prongs into either side of upper portion of base 47, and inserting male prongs protruding from base 47 into female holes on both half's of lower portion of external case 45 (this process can also be reversed having the prongs protruding from external case 40 and being inserted into pre-cored holes in base 47). As an alternative, external case 45 can be fused with base 47 through the manufacturing process.

It is contemplated that the lens cover 44 is made of molded plastic, although, other materials may also be used. The lens cover 44 mounts the groove at the upper portion of external case 45. It is contemplated that base 47 is rectangular in shape. It should be understood, however, that additional configurations and shapes may be used to form base 47, including, without limitation, oval, square, heart, octagonal, etc.

Base 47 further includes led backlight module 62, a power source, and a controller board. In addition, base 47 is comprised of the power and electronic component housing 48, and power housing cover 70 The power housing cover 70 is an elongated plastic cap and is configured to slidably insert into recess formed in the power and electronic component housing 48.

It is contemplated that the led backlight module 62 is connected to a controller board. The controller board is connected to a power source. It is contemplated that the power source is a lithium battery. It should be understood, however, that the power source can be of any other material with sufficient power to energize the light source. Such other materials include, without limitation, re-chargeable lithium-ion, oxyride, alkaline, solar, nickel-metal hydride, carbon zinc, zinc chloride etc. In addition, the controller board is connected to electronic wiring 64. The electronic wiring 64 is connected on one end to the controller board and on the opposite end connected to sliding switch 65.

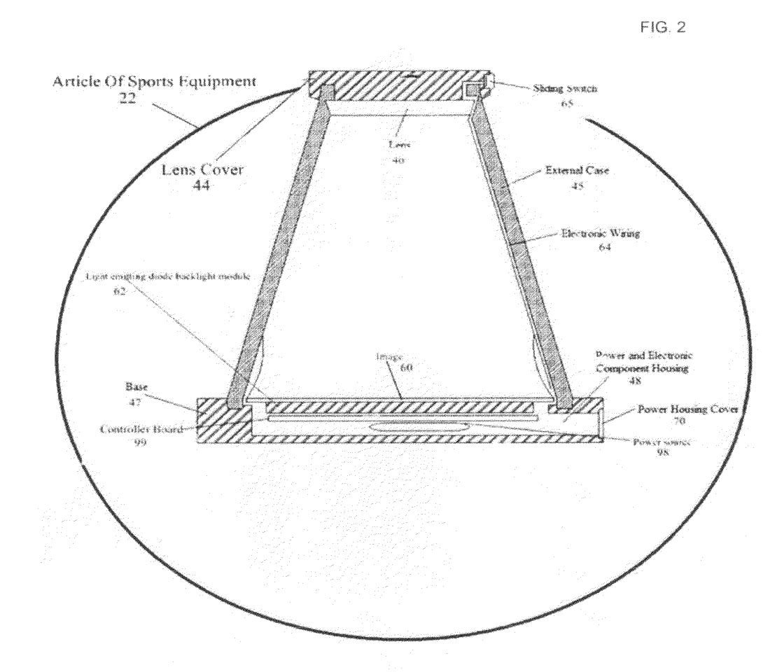

FIG. 2 shows a cross-sectional view of a ball, a sporting good, or an article of sports equipment 22, in combination, with the image viewer of FIG. 1, according to an embodiment of the invention. The sports equipment 22 is not limited to the design shown in FIG. 2. The sports equipment 22 can be any sports equipment, sporting good or item affiliated with any sport, worldwide, with sufficient capacity to accommodate adaptation into sports equipment image viewer. Examples of sports equipment are but not limited to tennis ball, golf ball, baseball, basketball, volleyball, lacrosse ball, bowling ball, football, rugby ball, soccer ball, baseball bat, golf club, hockey puck, hockey helmet, NASCAR car replicas, NASCAR helmet replicas, formula I car replicas, formula I helmet replicas, softball, basketball, football helmet, etc.

It is contemplated that a specially formed refractory object (mirroring image viewer of FIG. 1.) is inserted into the sports equipment 22 mold during the manufacturing process in order to create a cavity. It should be understood, however, that the sports equipment 22 can be cored by using a drill press, drill hammer drill, etc. The image viewer of FIG. 1 is inserted into the cavity. It is contemplated that after the refractory object has been removed and before the image viewer of FIG. 1 is inserted into sports equipment 22, the lens cover 44 is removed from its mounted position on the groove at the upper portion of external case 45. The image viewer is then inserted into pre-cored cavity of sports equipment 22 and the lens cover 44 is positioned such that it enters sports equipment 22 mounting the groove at the upper portion of external case 45, securing the image viewer of FIG. 1 in place. It should be understood, however, that lens cover 44 may not be removed and that the complete image viewer of FIG. 1 may be inserted into and united with sports equipment 22, and that an adhesive may be used to secure the image viewer of FIG. 1 in place. In addition, the image viewer may be secured with notches and a combination of fluff material to secure in place.

In operation, a human operator turns on the internal LED backlight module 62 utilizing sliding switch 65 and looks inside of sports equipment 22 in combination with the image viewer through lens 46 to gaze at or observe image within, utilizing uniform light. The sliding switch 65 allows user to turn the internal LED backlight module 62 switch either on or off. When the sliding switch is in the on position the electronic wiring 64 signals controller board to operate, and the controller board, in turn, instructs LED backlight module 62 to turn on, providing a uniform light source and enabling image or picture to become visible inside of sports equipment image viewer. The controller board can be a suitable microprocessor based programmable logic controller, chip, or the like for process control. Additionally, the controller may be programmed with an automatic shut-down of LED backlight module 62 after a predetermined amount of time has elapsed without the controller receiving input from the user. In the event that the LED backlight module 62 shuts down automatically then user moves the sliding switch into the off position and back to on position in order for LED backlight module 62 to turn on for image to be visible again.

There are additional possibilities with regard to viewing images in sports equipment image viewer. The basic design of alternative embodiments are generally the same as shown in FIG. 1 and FIG. 2 except that, in the alternative embodiment base 47 further comprises a display screen located at the front surface of the power and electronic component housing 48. The display screen is a flat panel liquid crystal display (LCD) that is approximately ½ inches wide by ½ inches high. The base 47 is not so limited, however, and the size of the display screen 60 may vary, and any other display type of screen may be used including passive display, active display, etc.

On one side of base 47, a universal serial bus (USB) port can be provided in order to receive data from an external drive. The external drive may be a camera, video camera, personal computer (CPU), etc. It should be understood that although a USB port is contemplated, it is possible to have other types of ports provided for the reception of data from external devices, such as FireWire/IEEE1394 cables, memory sticks and/or secure digital SD (SD) cards. When a USB cable is inserted into the USB port the data stored on an external device is taken by the controller and processed in order to display an image file/data on the display screen.

The data may be in any acceptable format that can accommodate image data, video data and/or music-sound data, such as JPG, GIF, mp3, etc. The controller further comprises memory so as to have the capacity to store a certain amount of data in order to store a specific number of pictures, videos, songs and the like. Approximately eight megabytes can be supplied in the controller. More or less memory may be provided, as needed.

In addition, controls may be provided. The controls are provided in order to manipulate the image on the display screen such as a presentation of the image, moving forward and backwards through a list of images, power, contrast, brightness, etc. The controls can also be used to manipulate the presentation of other data, such as volume, etc. When a user operates the controls, instructions are sent to the controller and the controller processes the data in order to provide the proper image to the screen and/or to manipulate the control of the screen or the data. Images can be viewed in either a manual control mode or an auto mode.

Where the controller is in manual control mode the user must push one of the control buttons to scroll through the images/digital pictures. Where the controller is in auto mode, the controller causes the images to automatically scroll after each image has been displayed a predetermined amount of time. Additionally, when in auto mode the controller may cause a short preprogrammed video to be automatically displayed a predetermined amount of time. The controller may further be programmed with an automatic shut down after a predetermined amount of time has passed without the controller receiving input from the user. Alternatively, the controller may be programmed such that only one pre-determined image/digital picture, set of images, or video maybe viewed by the user.

The base 47 can in this alternative embodiment include a rechargeable lithium battery. An external power source may be connected to the base 47 so as to recharge the battery. Additionally, the USB port may be used to connect the base 47 to a computer so as to recharge the battery.

As is apparent from the foregoing description, at least some embodiments of the invention provide for certain advantages. First, uniform lighting is provided, which allows observer to view image without spotting or specular reflection that prior art sports equipment viewers experience. Second, this uniform lighting allows users to view image when ambient lighting conditions are less than favorable. Third, the inventive sports equipment viewer has just one opening, such that the user does not become confused. Fourth, different articles of sports equipment can be easily modified to become viewers pursuant to embodiments of the invention, such that sports equipment viewers can be utilized for every known and future sport.

It is finally noted that, although specific embodiments have been illustrated and described herein, it will be appreciated by those of ordinary skill in the art that any arrangement calculated to achieve the same purpose may be substituted for the specific embodiments shown. This application is thus intended to cover any adaptations or variations of embodiments of the present invention. As such and therefore, it is manifestly intended that this invention be limited only by the claims and equivalents thereof.

1. A sports equipment image viewer comprising:
an article of sports equipment having a cavity and having only a single orifice; and,
an image viewer inserted into the cavity, the image viewer including an image, the image viewer externally exposed within the article of sports equipment only through the single orifice of the article of sports equipment,
such that the image is inside the article of sports equipment.

2. The sports equipment image view of claim 1, wherein the article of sports equipment is related to a sport, and the cavity is sufficiently size to accommodate the image viewer.

3. The sports equipment image view of claim 1, wherein the image viewer comprises an external case including a lens.

4. The sports equipment image viewer of claim 3, wherein the external case has a predetermined size and shape adapted to fit within the cavity of the article of sports equipment.

5. The sports equipment image viewer of claim 1, further comprising an illumination mechanism to illuminate the image.

6. The sports equipment image viewer of claim 5, wherein the illumination mechanism comprises a light source, the light source being completely internally disposed within the article of sports equipment.

7. The sports equipment image viewer of claim 6, wherein the light source comprises one of a light emitting diode and a light emitting diode backlight module.

8. The sports equipment image viewer of claim 6, wherein the light source a light emitting diode backlight module to communicate with a switch, a controller circuit board, and a power source.

9. A method comprising:
providing an article of sports equipment that is cored so that the article of sports equipment includes a cavity and such that the article of sports equipment has only a single orifice;
providing an image viewer adapted to be inserted within the article of sports equipment;
positioning the image viewer within the cavity of the article of sports equipment such that the image viewer is inserted into the cavity of the article of sports equipment and such that the image viewer is externally exposed within the article of sports equipment only through the single orifice;
securing the image viewer within the cavity of the article of sports equipment such that the image viewer is united with the article of sports equipment.
